(19) United States
(12) Patent Application Publication
(10) Pub. No.: US 2026/0311105 A1
(43) Pub. Date: Oct. 8, 2026

(54) Delivery System and Shared Control System

(71) Applicant: Pacport Co., Ltd, Tokyo (JP)

(72) Inventor: Shen YE, Tokyo (JP)

(73) Assignee: Pacport Co., Ltd, Tokyo (JP)

(21) Appl. No.: 19/476,201

(22) PCT Filed: May 1, 2023
(86) PCT No.: PCT/JP2023/017049

§ 371 Date: Oct. 17, 2025

(30) Foreign Application Priority Data
Apr. 20, 2023 (JP) 2023-069172

(51) Int. Cl. G06Q 10/083; G07C 9/00

(52) U.S. Cl. CPC G06Q 10/083; G07C 9/00896

(57) ABSTRACT

A business terminal includes an identification code reading unit that reads and identification code provided at a visible position at an entrance H1, and an unlock request unit that transmits a first signal to a delivery company server when the identification code reading unit reads the identification code. The delivery company server includes a request reception unit that receives the first signal from the business terminal, and a demand unit that transmits a second signal to a door control device server when the first signal is received by the request reception unit. The door control device server includes a demand reception unit 34 that receives the second signal from the delivery company server, and an instruction unit that transmits an unlock instruction for unlocking a door to a door control device when the second signal is received by the demand reception unit.

### CROSS-REFERENCE TO RELATED APPLICATIONS

The present application claims priorities under 35 U.S.C. § 365 to PCT/JP2023/017049 filed on May 1, 2023 and under 35 U.S.C. § 119 to Japanese Patent Application No. 2023-069172 filed on Apr. 20, 2023, both of which are incorporated herein by reference in their entireties.

### BACKGROUND

### Field

The present disclosure relates to a delivery system and a shared control system.

### Related Art

The description in this section merely provides information of background related to the present disclosure, and may not necessarily constitute the prior art.

As disclosed in Japanese Patent Application Laid-Open No. 2022-003559, a door control device is known which controls locking and unlocking of a door installed at the entrance of an apartment building. Conventionally, the method by which a delivery person delivering a package unlocks the door has typically been for the delivery person to manually input the slip number attached to the package into the door control device at the entrance of the apartment building which is a delivery destination.

Typically, the slip number consists of ten or more digits. Therefore, in the above-mentioned unlocking method, it is troublesome for the delivery person to manually input such a slip number.

In view of the above-mentioned problems, a delivery system and a shared control system which simplifies the unlocking operation of the door in the apartment buildings by the delivery person is provided.

### SUMMARY

A delivery system according to a first aspect of the present disclosure includes: a shared control device including a control unit that controls one or more shared devices on a movement route from an entrance of an apartment building to each room; a control device server capable of communicating with the shared control device; a delivery company server managed by a delivery company of a package and capable of communicating with the control device server; and a business terminal owned by a delivery person who delivers the package and capable of communicating with the delivery company server, the business terminal including an identification code reading unit that reads an identification code provided in a visible position in the apartment building, and a control request unit that transmits a first signal to the delivery company server when the identification code reading unit reads the identification code, the delivery company server including a request reception unit that receives the first signal from the business terminal, and a demand unit that transmits a second signal to the control device server when the request reception unit receives the first signal, and the control device server including a demand reception unit that receives the second signal from the delivery company server, and an instruction unit that transmits an instruction for controlling the shared devices to the shared control device when the demand reception unit receives the second signal.

Furthermore, a delivery system according to a second aspect of the present disclosure includes: a door control device including a control unit that controls locking and unlocking of a door installed at an entrance of an apartment building; a door control device server capable of communicating with the door control device; a delivery company server that is managed by a delivery company of a package and capable of communicating with the door control device server; and a business terminal that is owned by a delivery person who delivers the package to the apartment building and capable of communicating with the delivery company server, the business terminal including an identification code reading unit that reads an identification code provided at a visible position at the entrance, and an unlock request unit that transmits a first signal to the delivery company server when the identification code reading unit reads the identification code, the delivery company server including a request reception unit that receives the first signal from the business terminal, and a demand unit that transmits a second signal to the door control device server when the request reception unit receives the first signal, and the door control device server including a demand reception unit that receives the second signal from the delivery company server, and an instruction unit that transmits an unlock instruction for unlocking the door to the door control device when the demand reception unit receives the second signal.

Furthermore, in a third aspect of the present disclosure, the identification code includes device identification information that identifies the door control device, the business terminal further includes an identification unit that acquires the device identification information from the identification code read by the identification code reading unit, the first signal and the second signal include the device identification information acquired by the identification unit, and the instruction unit transmits the unlock instruction to the door control device indicated by the device identification information included in the second signal.

Furthermore, in a fourth aspect of the present disclosure, the identification code further includes server identification information that identifies the door control device server, the identification unit further acquires the server identification information from the identification code read by the identification code reading unit, the first signal further includes the server identification information acquired by the identification unit, and the demand unit transmits the second signal to the door control device server indicated by the server identification information included in the first signal.

Furthermore, in a fifth aspect of the present disclosure, the door control device further includes a display unit that displays the identification code on a screen, the identification code includes random number information that is changed at a predetermined timing, the business terminal further includes an identification unit that acquires the random number information from the identification code read by the identification code reading unit, the first signal and the second signal include the random number information acquired by the identification unit, the door control device server includes a random number determination unit that determines whether or not the random number information included in the unlock demand received by the demand reception unit is the newest, and the instruction unit transmits the unlock instruction when the second signal is received by the demand reception unit and when the random number determination unit determines that the random number information is the newest.

Furthermore, a shared control system according to a sixth aspect of the present disclosure includes: a shared control device including a control unit that controls one or more shared devices located on a movement route from an entrance of an apartment building to each room; and a control device server that includes a reception unit that receives a signal from a business terminal or a delivery company server linked to the business terminal when the business terminal reads an identification code provided in a visible position in the apartment building, and an instruction unit that transmits an instruction for controlling the shared devices to the shared control device when the reception unit receives the signal.

Furthermore, a shared control system according to a seventh aspect of the present disclosure includes: a door control device including a control unit that controls locking and unlocking of a door installed at an entrance of an apartment building; and a door control device server including a reception unit that receives a signal from a business terminal or a delivery company server linked to the business terminal when the business terminal reads an identification code provided in a visible position at the entrance, and an instruction unit that transmits an unlock instruction for unlocking the door to the door control device when the reception unit receives the signal.

### Advantageous Effects

The delivery system and the shared control system according to the present disclosure can simplify the unlocking operation of the door of the apartment buildings by the delivery person.

### BRIEF DESCRIPTION OF THE DRAWINGS

FIG. 1 is a schematic diagram illustrating a delivery system according to an embodiment of the present disclosure.

FIG. 2 is a block diagram schematically illustrating an example of a hardware configuration of the delivery system illustrated in FIG. 1.

FIG. 3 is a block diagram schematically illustrating an example of a functional configuration of the delivery system illustrated in FIG. 1.

FIG. 4 is a schematic diagram illustrating an example of a state where a barcode provided on the package shown in FIG. 1 is read by a business terminal.

FIG. 5 is a perspective view schematically showing an example of an entrance of the apartment building shown in FIG. 1.

FIG. 6 is a schematic diagram showing an example of a state where a QR code (registered trademark, the same applies hereinafter) displayed on the door control device shown in FIG. 1 is read by the business terminal.

FIG. 7 is a flowchart illustrating a processing performed by the delivery system shown in FIG. 1.

### DESCRIPTION OF EMBODIMENTS

Hereinafter, the embodiments of the present disclosure will be described with reference to the accompanying drawings. In order to facilitate understanding of the description, the same components in each drawing are denoted by the same reference numerals as much as possible, and duplicate descriptions will be appropriately omitted.

### EMBODIMENT

### Configuration

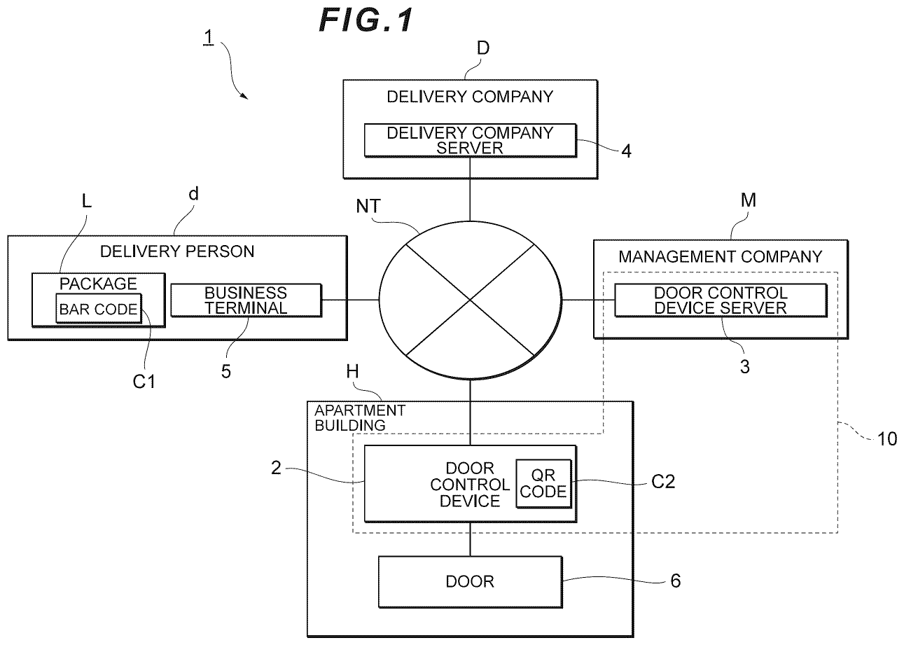

FIG. 1 is a schematic diagram illustrating the delivery system 1 according to the embodiment (referred to as “the present embodiment”) of the present disclosure.

As shown in FIG. 1, the delivery system 1 includes a shared control system 10, a delivery company server 4, and a business terminal 5 according to the present embodiment, as main parts. The shared control system 10 includes a door control device 2 and a door control device server 3, as main parts.

The door control device 2 is a device that controls the locking and unlocking of the door 6 installed at an entrance H1 (omitted in FIG. 1) of an apartment building H. In addition, there may be cases where different door control devices 2 are provided in multiple apartment buildings H, respectively.

The door control device server 3 is a server which is managed by a management company M of the door control device 2 and which is capable of communicating with the door control device 2 via a communication network NT (such as the Internet). In addition, there may be cases where different door control devices 2 are managed by a plurality of management companies M, respectively.

The delivery company server 4 is a server which is managed by a delivery company D of the package L and which is capable of communicating with the door control device server 3 via the communication network NT.

The business terminal 5 is a mobile communication terminal (such as a mobile phone, a tablet or a smartphone) owned by the delivery person d who delivers the package L to the apartment building H, and is capable of communicating with the delivery company server 4 via the communication network NT.

The bar code C1 shown in FIG. 1 is a barcode (service code) affixed to the surface of the package L (or packaging; for example, cardboard boxes and envelopes). The barcode C1 includes slip number information 40A (service number information) that is set for each package L by the delivery company D. The slip number information 40A is information that links the slip number of the package L, the delivery address of the package L, the recipient of the package L, and the sender of the package L.

The QR code (registered trademark) C2 shown in FIG. 1 is an identification code that is displayed on the screen by the door control device 2. The QR code C2 contains a server ID 41A (server identification information) that identifies the door control device server 3, a device ID 41B (device identification information) that identifies the door control device 2, and random number information 41C that is randomly changed at a predetermined timing (each one is omitted in FIG. 1).

Incidentally, for the sake of simplicity, FIG. 1 shows a state in which the delivery system 1 includes one shared control system 10, and the shared control system 10 includes one door control device 2 and one door control device server 3.

However, in the present embodiment, there may be one or more shared control systems 10 included in the delivery system 1, and there may be one or more door control devices 2 included in one shared control system 10. Therefore, for example, there may be a case where there are three shared control systems 10 (i.e., three door control device servers 3) and six door control devices 2.

### Hardware Configuration

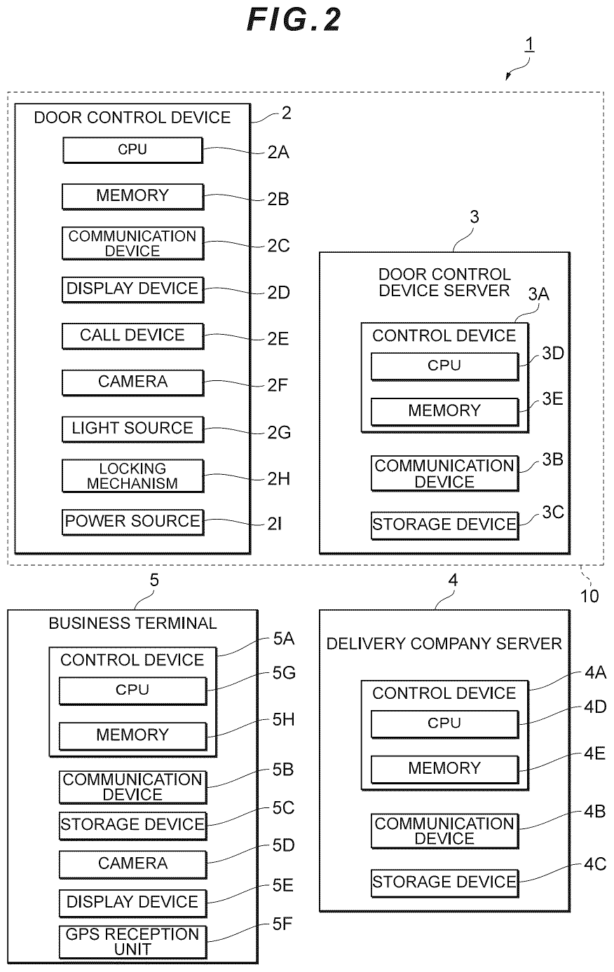

FIG. 2 is a block diagram schematically illustrating an example of a hardware configuration of the delivery system 1 illustrated in FIG. 1.

As shown in FIG. 2, first, the door control device 2 includes a CPU (Central Processing Unit) 2A, a memory 2B, a communication device 2C, a display device 2D, a call device 2E, a camera 2F, a light source 2G, a locking mechanism 2H, and a power source 2I.

The CPU 2A controls various configurations of the door control device 2.

The memory 2B stores the device ID 41B of the door control device 2, programs, and the like.

The communication device 2C is formed by a communication interface and the like for communicating with an external device. The communication device 2C transmits and receives various information and/or various data to and from the door control device server 3, for example.

The display device 2D displays the other person of the call and the QR code C2. The display device 2D also has a touch panel display and thus serves as an operation means for performing various operations (however, an operation means may be provided separately).

The communication device 2E is configured to be capable of communicating with the resident of the room whose number is input by the above-mentioned operating means.

The camera 2F captures an image in the front direction of the door control device 2.

The light source 2G is controlled by the CPU 2A as to its emission of light. The light source 2G may be a diode or a lamp etc.

The locking mechanism 2H locks and unlocks the door 6.

The power supply 2I supplies the power to the CPU 2A, memory 2B, and the like. The power source 2I is preferably, for example, a battery.

Next, the door control device server 3 includes a control device 3A, a communication device 3B, and a storage device 3C. The control device 3A mainly includes a CPU 3D and a memory 3E.

The control device 3A functions as various functional means by means of the CPU 3D executing the predetermined programs stored in the storage device 3C, the memory 3E, or the like.

The communication device 3B is configured with a communication interface and the like that communicates with (for example, transmits and receives various information and/or various data to and from) external devices.

The storage device 3C is configured with a hard disk and the like. The storage device 3C stores various programs and various information required for executing the processing in the control device 3A, as well as information on the results of the processing.

The door control device server 3 can be realized with an information processing device such as a dedicated or general-purpose server computer. Furthermore, the door control device server 3 may be configured with a single information processing device, or may be configured with a plurality of information processing devices distributed over the communication network NT. Furthermore, FIG. 2 only shows a portion of the main hardware configuration of the door control device server 3, and the door control device server 3 may include other configurations that are generally included in a server.

The delivery company server 4 includes a control device 4A, a communication device 4B, and a storage device 4C. The control device 4A mainly includes a CPU 4D and a memory 4E. These are similar to the control device 3A, the communication device 3B, the storage device 3C, the CPU 3D, and the memory 3E in the door control device server 3, and the description thereof will be omitted.

The delivery company server 4 can also be realized with an information processing device such as a dedicated or general-purpose server computer. The delivery company server 4 may also be configured with a single information processing device, or may be configured with a plurality of information processing devices distributed over the communications network NT. Furthermore, FIG. 2 only shows a portion of the main hardware configuration of the delivery company server 4, and the delivery company server 4 may include other configurations that are generally included in a server.

The hardware configuration of the business terminal 5 includes a control device 5A, a communication device 5B, and a storage device 5C. The control device 5A mainly includes a CPU 5G and a memory 5H. These are similar to the control device 3A, the communication device 3B, the storage device 3C, the CPU 3D, and the memory 3E in the door control device server 3.

Furthermore, the hardware configuration of the business terminal 5 includes a camera 5D, a display device 5E, and a GPS reception unit 5F.

The camera 5D captures various images. For example, it can capture an image of the barcode C1 or the QR code C2 in FIG. 1 and read information thereof.

The display device 5E displays various information and/or various data transmitted and received by the communication device 5B. The display device 5E may also have a touch panel display so as to function as an operation means for performing various operations (or an operation means may be provided separately).

The GPS reception unit 5F receives GPS (Global Positioning System) signals to identify its own position.

FIG. 2 only shows a portion of the main hardware configuration of the business terminal 5, and the business terminal 5 may include other configurations that are typically included in mobile communication terminals (such as mobile phones, tablets, smartphones).

### Functional Configuration of Business Terminal

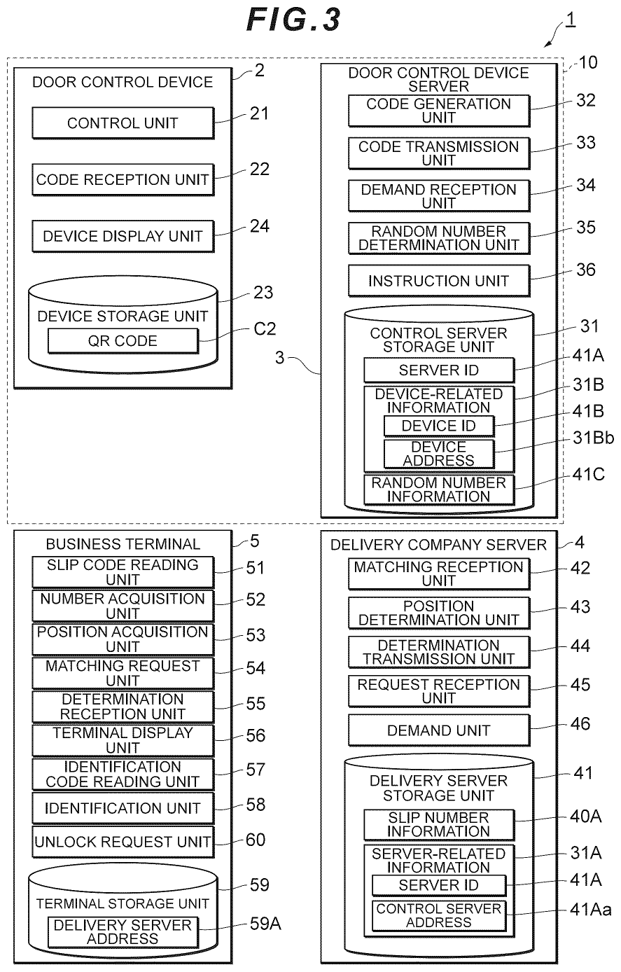

FIG. 3 is a block diagram schematically illustrating an example of a functional configuration of the delivery system 1 illustrated in FIG. 1.

First, as shown in FIG. 3, the business terminal 5 includes a slip code reading unit 51, a number acquisition unit 52, a position acquisition unit 53, a matching request unit 54, a determination reception unit 55, a terminal display unit 56, an identification code reading unit 57, an identification unit 58, a terminal storage unit 59, and an unlock request unit 60.

The slip code reading unit 51 reads the bar code C1.

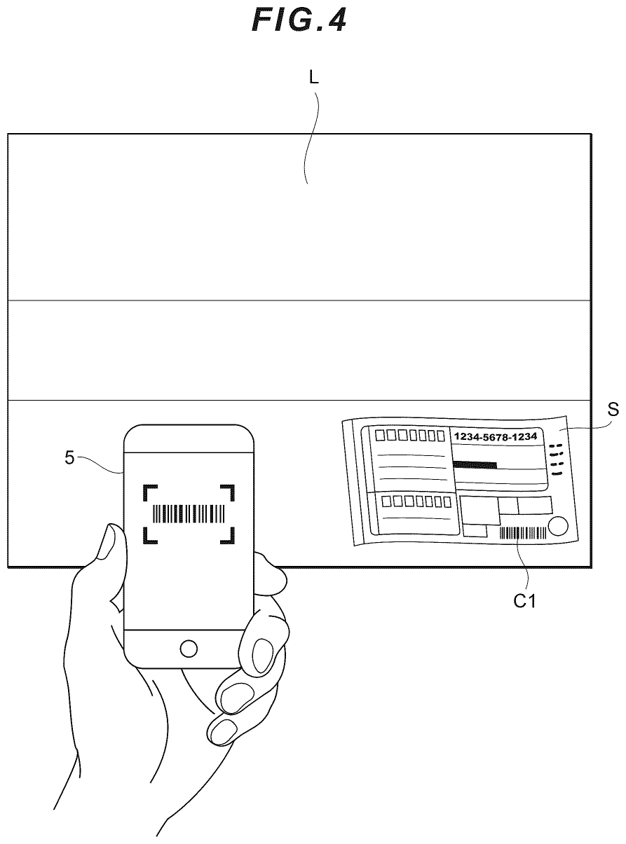

FIG. 4 is a schematic diagram illustrating an example of a state where the barcode C1 provided on the package L shown in FIG. 1 is read by the business terminal 5.

As shown in FIG. 4, the packaging material of the package L (or packaging; for example, cardboard boxes and envelopes) has a slip S affixed to its surface. This slip S includes the bar code C1 including slip number information 40A (omitted in FIG. 4). The slip code reading unit 51 captures an image of this bar code C1 and reads it.

The number acquisition unit 52 acquires the slip number information 40A from the barcode C1 read by the slip code reading unit 51.

The position acquisition unit 53 acquires its own position information based on the GPS signal.

The matching request unit 54 transmits a matching request (third signal) including the slip number information 40A acquired by the number acquisition unit 52 and the position information acquired by the position acquisition unit 53 to the delivery company server 4.

The determination reception unit 55 receives the determination result transmitted from the delivery company server 4.

The terminal display unit 56 displays the determination result received by the determination reception unit 55 on the screen.

The identification code reading unit 57 reads the QR code C2 displayed on the screen of a device display unit 24 of the door control device 2.

The identification unit 58 acquires the server ID 41A, the device ID 41B, and the random number information 41C from the QR code C2 read by the identification code reading unit 57.

The terminal storage unit 59 stores a delivery server address 59A which is the server address (destination address) of the delivery company server 4.

When the identification code reading unit 57 reads the QR code C2, the unlock request unit 60 transmits an unlock request (first signal) to the delivery company server 4 on the basis of the delivery server address 59A of the delivery company server 4 stored in the terminal storage unit 59. The unlock request includes the server ID 41A, the device ID 41B, and the random number information 41C acquired by the identification unit 58.

### Functional Configuration of Delivery Company Server

As shown in FIG. 3, the delivery company server 4 includes a delivery server storage unit 41, a matching reception unit 42, a position determination unit 43, a determination transmission unit 44, a request reception unit 45, and a demand unit 46.

The delivery server storage unit 41 stores slip number information 40A and server-related information 31A.

The server-related information 31A is information in which the server ID 41A is linked with a control server address 41Aa which is the server address (destination) of the door control device server 3.

The matching reception unit 42 receives the matching request transmitted from the business terminal 5.

When the matching request is received by the matching reception unit 42, the position determination unit 43 determines whether or not the position information matches the delivery address based on the slip number information 40A.

The determination transmission unit 44 transmits the determination result by the position determination unit 43 to the business terminal 5.

The request reception unit 45 receives the unlock request from the business terminal 5.

When the position determination unit 43 determines that the position information matches the delivery address (positive determination) and the request reception unit 45 receives the unlock request, the demand unit 46 first extracts the control server address 41Aa linked to the server ID 41A included in the unlock request on the basis of the server-related information 31A stored in the delivery server storage unit 41.

Furthermore, the demand unit 46 transmits the unlock demand (second signal) to the door control device server 3 on the basis of the extracted control server address 41Aa. That is, the demand unit 46 transmits the unlock demand to the door control device server 3 indicated by the server ID 41A included in the unlock request. The unlock demand includes the device ID 41B and random number information 41C.

### Functional Configuration of Door Control Device Server

As shown in FIG. 3, the door control device server 3 includes a control server storage unit 31, a code generation unit 32, a code transmission unit 33, a demand reception unit 34, a random number determination unit 35, and an instruction unit 36.

The control server storage unit 31 stores the server ID 41A of the door control device server 3 itself, device-related information 31B for each door control device 2 (of the management company M that manages the door control device server 3) linked to the door control device server 3, and random number information 41C.

The device-related information 31B is information in which the device ID 41B is linked with a device address 31Bb which is the address (destination) of the door control device 2.

The code generation unit 32 generates the QR code C2 at each predetermined timing.

Specifically, the code generation unit 32 generates (changes) random number information 41C at each predetermined timing, and generates the QR code C2 that includes this together with the server ID 41A and the device ID 41B that are pre-stored in the control server storage unit 31 (the QR code C2 is generated for each door control device 2).

The “predetermined timing” may be, for example, the timing when a predetermined time (such as one minute) has elapsed. Furthermore, the random number information 41C is stored in the control server storage unit 31 every time it is generated (changed).

Every time the QR code C2 is generated by the code generation unit 32, the code transmission unit 33 transmits the generated QR code C2 to each door control device 2 on the basis of each device address 31Bb.

The demand reception unit 34 receives the unlock demand from the delivery company server 4.

The random number determination unit 35 determines whether or not the random number information 41C included in the unlock demand received by the demand reception unit 34 is the newest.

When the demand reception unit 34 receives the unlock demand and the random number determination unit 35 determines that the random number information 41C is the newest, the instruction unit 36 first identifies the device address 31Bb linked to the device ID 41B included in the unlock demand on the basis of the device-related information 31B stored in the control server storage unit 31.

Furthermore, the instruction unit 36 transmits an unlock instruction for unlocking the door 6 to the door control device 2 on the basis of the identified device address 31Bb. That is, the instruction unit 36 transmits the unlock instruction to the door control device 2 indicated by the device ID 41B included in the unlock demand. When the door control device 2 receives the unlock instruction, it unlocks the door 6.

Although it is not shown, the control server storage unit 31 may store the delivery server address 59A of the delivery company server 4. Then, when the demand reception unit 34 receives the unlock demand from the address other than the delivery server address 59A, the instruction unit 36 does not have to issue the unlock instruction. As a result, when a third party reads the QR code C2 and transmits the unlock demand directly to the door control device server 3, the unlock instruction is not issued, improving the security.

### Functional Configuration of Door Control Device

As shown in FIG. 3, the door control device 2 includes a control unit 21, a code reception unit 22, a device storage unit 23, and a device display unit 24 (display unit).

The control unit 21 controls the locking and unlocking of the door 6 installed at the entrance H1 of the apartment building H.

The code reception unit 22 receives the QR code C2 from the door control device server 3.

The device storage unit 23 stores the QR code C2 received by the code reception unit 22.

The device display unit 24 displays the QR code C2 received by the code reception unit 22 (stored in the device storage unit 23) on the screen.

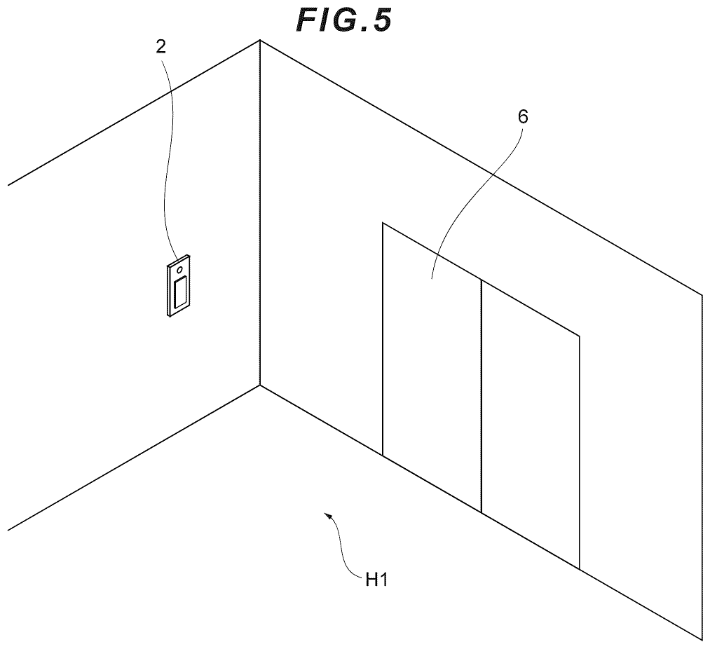

FIG. 5 is a perspective view schematically showing an example of the entrance H1 of the apartment building H shown in FIG. 1.

As shown in FIG. 5, the door control device 2 is provided near the door 6 at the entrance H1 of the apartment building, with the display device 2D (user interface portion) exposed.

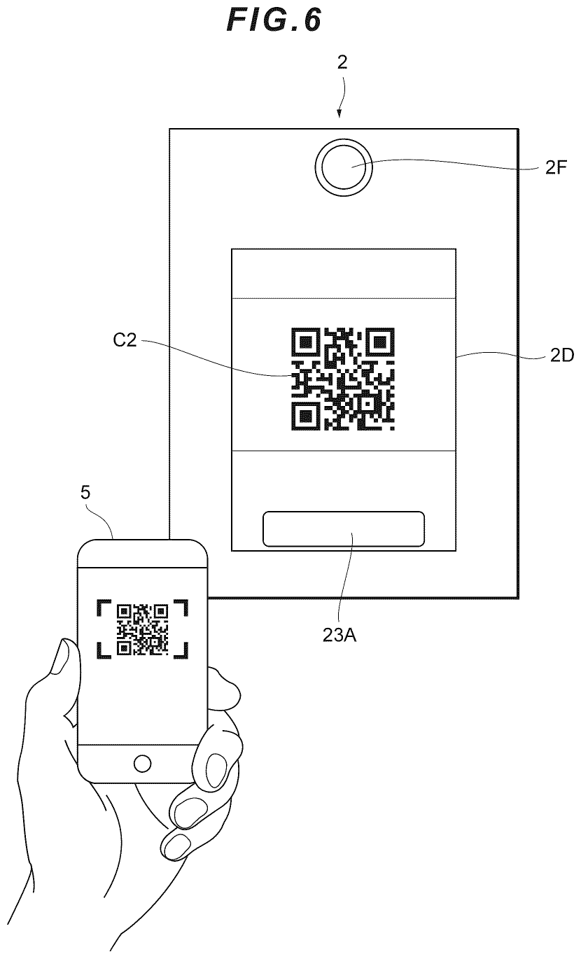

FIG. 6 is a schematic diagram showing an example of the state where the QR code C2 displayed by the door control device 2 shown in FIG. 1 is read by the business terminal 5.

As shown in FIG. 6, the camera 2F is provided above the user interface portion of the door control device 2, and the touch panel display of the display device 2D is provided in the center. Furthermore, a clickable display button 23A is displayed on the touch panel display. When the delivery person d clicks on the display button 23A, the QR code C2 is displayed on the display device 2D. Alternatively, the delivery person d can call the recipient by inputting the room number on a number input screen (not shown) displayed on the display device 2D. If the recipient is not at home (if the recipient does not reply after a certain period of time has passed), the QR code C2 can be automatically displayed. The device display unit 24 controls these operations.

When an image of the QR code C2 displayed on the screen is captured by the camera 5D of the business terminal 5, the identification code reading unit 57 reads the QR code C2.

### Processing

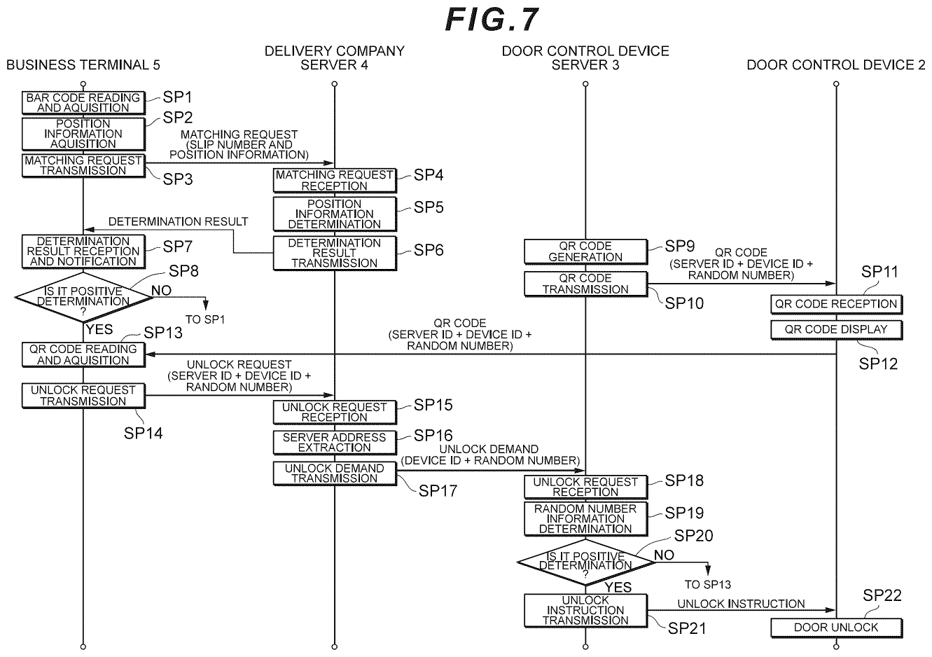

The processing performed by the delivery system 1 will be described in detail below with reference to the flowchart in FIG. 7. The following steps are merely an example, and the order and content of the steps can be changed as appropriate.

Further, for the sake of simplicity, one door control device 2 and one door control device server 3 are shown in FIG. 7.

### (Step SP1)

When the delivery person d arrives at the entrance H1 of the apartment building H, he or she reads the barcode C1 provided on the package L by means of the slip code reading unit 51, by his or her business terminal 5. Furthermore, the number acquisition unit 52 acquires the slip number information from the barcode C1 read by the slip code reading unit 51.

Subsequently, the processing proceeds to step SP2.

### (Step SP2)

The position acquisition unit 53 of the business terminal 5 acquires its own position information by means of the GPS signal.

Subsequently, the processing proceeds to step SP3.

### (Step SP3)

The matching request unit 54 of the business terminal 5 transmits the matching request including the slip number information acquired by the number acquisition unit 52 and the position information acquired by the position acquisition unit 53 to the delivery company server 4.

Subsequently, the processing proceeds to step SP4.

### (Step SP4)

The matching reception unit 42 of the delivery company server 4 receives the matching request from the business terminal 5.

Subsequently, the processing proceeds to step SP5.

### (Step SP5)

The position determination unit 43 of the delivery company server 4 determines whether or not the position information matches the delivery address (based on the slip number information 40A) of the package L linked to the slip number.

Subsequently, the processing proceeds to step SP6.

### (Step SP6)

The determination transmission unit 44 of the delivery company server 4 transmits the determination result by the position determination unit 43 to the business terminal 5.

Subsequently, the processing proceeds to step SP7.

### (Step SP7)

The determination reception unit 55 of the business terminal 5 receives the determination result transmitted from the delivery company server 4. Furthermore, the terminal display unit 56 displays the determination result received by the determination reception unit 55 on the screen.

Subsequently, the processing proceeds to step SP8.

### (Step SP8)

The step branches depending on whether or not the determination result received by the determination reception unit 55 of the business terminal 5 is a determination result (positive determination) that the position information matches the delivery address. If the determination result is a matching one (in case of the positive determination), the processing proceeds to step SP13. If the determination result is a non-matching one (in case of the negative determination), the delivery person d inquires with the delivery company D or checks a map, etc., and moves so that the position information matches the delivery address. Then, the processing proceeds to step SP1.

### (Step SP9)

The code generation unit 32 of the door control device server 3 generates the QR code C2 at the predetermined timing, for example once every minute.

Subsequently, the processing proceeds to step SP10.

### (Step SP10)

The code transmission unit 33 of the door control device server 3 transmits the QR code C2 generated by the code generation unit 32 to the door control device 2 (every time it is generated by the code generation unit 32).

Subsequently, the processing proceeds to step SP11.

### (Step SP11)

The code reception unit 22 of the door control device 2 receives the QR code C2 from the door control device server 3. Subsequently, the processing proceeds to step SP12.

### (Step SP12)

The device display unit 24 of the door control device 2 displays the QR code C2 received by the code reception unit 22 on the screen.

Subsequently, the processing proceeds to step SP13.

### (Step SP13)

The identification code reading unit 57 of the business terminal 5 reads the QR code C2 displayed on the screen of the device display unit 24 of the door control device 2. This QR code C2 includes the server ID 41A, the device ID 41B, and random number information 41C.

Subsequently, the processing proceeds to step SP14.

### (Step SP14)

When the identification code reading unit 57 reads the QR code C2, the unlock request unit 60 of the business terminal 5 transmits the unlock request to the delivery server address 59A stored in the terminal storage unit 59. This unlock request includes the server ID 41A, the device ID 41B, and random number information 41C.

Subsequently, the processing proceeds to step SP15.

### (Step SP15)

The request reception unit 45 of the delivery company Server 4 receives the unlock request from the business terminal 5.

Subsequently, the processing proceeds to step SP16.

### (Step SP16)

The demand unit 46 of the delivery company server 4 extracts the control server address 41Aa linked to the server ID 41A included in the unlock request on the basis of the Server-related information 31A stored in the delivery server storage unit 41.

Subsequently, the processing proceeds to step SP17.

### (Step SP17)

The demand unit 46 of the delivery company server 4 transmits the unlock demand (second signal) to the extracted control server address 41Aa. That is, the unlock demand (second signal) is transmitted to the door control device server 3 indicated by the server ID 41A included in the unlock request. The unlock demand includes the device ID 41B and random number information 41C.

Subsequently, the processing proceeds to step SP18.

### (Step SP18)

The demand reception unit 34 of the door control device server 3 receives the unlock demand from the delivery company server 4.

Subsequently, the processing proceeds to step SP19.

### (Step SP19)

The random number determination unit 35 of the door control device server 3 determines whether or not the random number information 41C included in the unlock demand received by the demand reception unit 34 is the newest.

Subsequently, the processing proceeds to step SP20.

### (Step SP20)

The step branches depending on whether or not the random number determination unit 35 of the door control device server 3 determines that the random number information 41C is the newest (positive determination). If the determination result is that it is the newest (in case of the positive determination), the processing proceeds to step SP21. If the determination result is that it is not the newest (in case of the negative determination), the processing proceeds to step SP13.

### (Step SP21)

The instruction unit 36 of the door control device server 3 transmits the unlock instruction for unlocking the door 6 to the door control device 2 indicated by the device ID 41B included in the unlock demand.

Subsequently, the processing proceeds to step SP22.

### (Step SP22)

The door control device 2, which received the unlock instruction from the door control device server 3, unlocks the door 6.

Subsequently, the processing ends.

The processing performed by the delivery system 1 according to the present embodiment has been described as above.

### Operation and Effect

The delivery system 1 according to the present embodiment includes: the door control device 2 including the control unit 21 that controls locking and unlocking of the door 6 installed at the entrance H1 of the apartment building H; the door control device server 3 that is managed by the management company M of the door control device 2 and capable of communicating with the door control device 2; the delivery company server 4 that is managed by the delivery company D of a package L and capable of communicating with the door control device server 3; and the business terminal 5 that is owned by the delivery person d who delivers the package L to the apartment building H and capable of communicating with the delivery company server 4. The business terminal 5 includes the identification code reading unit 57 that reads the identification code (QR code C2) provided at the visible position at the entrance H1, and the unlock request unit 60 that transmits the first signal (unlock request) to the delivery company server 4 when the code reading unit 57 reads the identification code. The delivery company server 4 includes the request reception unit 45 that receives the first signal from the business terminal 5, and the demand unit 46 that transmits the second signal (unlock demand) to the door control device server 3 when the first signal is received by the request reception unit 45. The door control device server 3 includes the demand reception unit 34 that receives the second signal from the delivery company server 4, and the instruction unit 36 that transmits the unlock instruction for unlocking the door 6 to the door control device 2 when the second signal is received by the demand reception unit 34.

In this manner, in the present embodiment, the delivery person d can unlock the door 6 by reading the identification code by means of the business terminal 5, which simplifies the unlocking operation of the door 6 of the apartment building H by the delivery person d.

Furthermore, in the present embodiment, the identification code includes device identification information (device ID 41B) that identifies the door control device 2, the business terminal 5 further includes the identification unit 58 that acquires the device identification information from the identification code read by the identification code reading unit 57, the first signal and the second signal include the device identification information acquired by the identification unit 58, and the instruction unit 36 transmits the unlock instruction to the door control device 2 indicated by the device identification information included in the second signal.

In this manner, in the present embodiment, when the door control devices 2 are provided in multiple apartment buildings H, the door control device 2 of the apartment building H of the delivery destination can be identified, so that the door 6 of the apartment building H of the delivery destination can be unlocked.

Furthermore, in the present embodiment, the identification code further includes server identification information (server ID 41A) that identifies the door control device server 3, the identification unit 58 further acquires the server identification information from the identification code read by the identification code reading unit 57, the first signal further includes the server identification information acquired by the identification unit 58, and the demand unit 46 transmits the second signal to the door control device server 3 indicated by the server identification information included in the first signal.

In this manner, in the present embodiment, when the door control devices 2 of different management companies M are provided in the multiple apartment buildings H, the door control device 2 of the apartment building H of the delivery destination and its management company M can be identified, so that the door 6 of the apartment building H of the delivery destination can be unlocked.

Furthermore, in the present embodiment, the door control device 2 further includes the display unit (device display unit 24) that displays the identification code on the screen, the identification code includes random number information 41C that is changed at a predetermined timing, the business terminal 5 further includes the identification unit 58 that acquires the random number information 41C from the identification code read by the identification code reading unit 57, the first signal and the second signal include the random number information 41C acquired by the identification unit 58, the door control device server 3 includes the random number determination unit 35 that determines whether or not the random number information 41C included in the unlock demand received by the demand reception unit 34 is the newest, and the instruction unit 36 transmits the unlock instruction when the second signal is received by the demand reception unit 34 and when the random number determination unit 35 determines that the random number information 41C is the newest.

In this manner, in the present embodiment, the identification code changes at each predetermined timing, so that it is possible to prevent the identification code from being stolen.

Furthermore, in the present embodiment, the door control device server 3 further includes the code generation unit 32 that generates the identification code, and the code sending unit 33 that transmits the identification code generated by the code generation unit 32 to the door control device 2, the door control device 2 further includes the code reception unit 22 that receives the identification code from the door control device server 3, and the display unit displays the identification code received by the code reception unit 22 on the screen.

In this manner, in the present embodiment, the door control device server 3 generates the identification code, making it easier to determine whether or not the random number information 41C contained in the second signal is correct, compared to the case where the identification code is generated by another device.

Furthermore, in the present embodiment, the business terminal 5 further includes the slip code reading unit 51 that reads the service code (barcode C1) including the service number (slip number information 40A) set for the respective packages L, the number acquisition unit 52 that acquires service number information from the service code read by the slip code reading unit 51, the position acquisition unit 53 that acquires its own position information, and the matching request unit 54 that transmits the third signal including the service number information acquired by the number acquisition unit 52 and the position information acquired by the position acquisition unit 53 to the delivery company server 4. The delivery company server 4 further includes the matching reception unit 42 that receives the third signal from the business terminal 5, and the position determination unit 43 that, when the matching reception unit 42 receives the third signal, determines whether or not the position information matches the delivery address of the package L linked to the service number information. When the position determination unit 43 determines that the position information matches the delivery address and when the request reception unit 45 receives the first signal, the demand unit 46 transmits the second signal to the door control device server 3.

In this manner, the present embodiment can prevent the delivery person d from making a mistake in the delivery destination.

Furthermore, the shared control system 10 according to the present embodiment has the door control device 2 including the control unit 21 that controls locking and unlocking of the door 6 installed at the entrance H1 of the apartment building H; and the door control device server 3 includes the reception unit (demand reception unit 34) that receives the signal (first signal or second signal) from the business terminal 5 or the delivery company server 4 linked to the business terminal 5 when the business terminal 5 reads the identification code provided in the visible position at the entrance H1, and the instruction unit 36 that transmits the unlock instruction when the reception unit receives the signal.

In this manner, in the present embodiment, the delivery person d can unlock the door 6 by reading the identification code by means of the business terminal 5, which simplifies the unlocking operation of the door 6 of the apartment building H by the delivery person d.

### MODIFICATION EXAMPLE

Note that the present disclosure is not limited to the specific examples described above. That is, the above specific examples including optional design change added thereto by those skilled in the art are also included within the scope of the present disclosure as long as they have the characteristic of the present disclosure. Furthermore, each of the elements of the aforementioned embodiment and the modification example to be described later can be combined when technically possible, and such combinations are also included within the scope of the present disclosure without departing from the characteristic of the present disclosure.

For example, the aforementioned embodiment is described by referring to the case where the QR code C2 is generated at a predetermined timing by the code generation unit 32 provided in the door control device server 3. However, it is also possible for the door control device 2 to generate the QR code C2 at a predetermined timing. That is, the code generation unit 32 may be provided in the door control device 2.

In that case, the code transmission unit 33 and the code reception unit 22 may be eliminated. Alternatively, the code transmission unit 33 may be provided in the door control device 2 and the code reception unit 22 may be provided in the door control device server 3, so that the QR code C2 is transmitted from the door control device 2 to the door control device server 3.

Furthermore, in the aforementioned embodiment, the QR code C2 is displayed on the screen by the door control device 2, but instead, the QR code C2 may be affixed to a wall surface near the entrance H1 of the apartment building H. That is, the QR code C2 may be provided at a position at the entrance H1 of the apartment building H that is visible to the delivery person d. In that case, the code generation unit 32 and the code transmission unit 33 are not necessary, and the QR code C2 may be replaced at regular intervals instead of being generated at a predetermined timing.

Furthermore, the QR code C2 (identification code) may be a bar code or other code, and the bar code C1 (service code) in the aforementioned embodiment may be a QR code or other code. That is, the identification code provided at the visible position at the entrance H1 and the service code affixed to the surface of the package L, as described in the aforementioned embodiment, may be a one-dimensional code or a two-dimensional code, respectively, and the type of code is not limited.

The aforementioned embodiment is described by referring to the case where there are one delivery company server 4 and one business terminal 5. However, as a matter of course, there may be a plurality of these components. In this case, the terminal storage unit 59 of each business terminal 5 may store the delivery server address 59A of the delivery company server 4 linked to each business terminal 5.

Furthermore, the control server storage unit 31 of the door control device server 3 may store the delivery server address 59A for each delivery company server 4.

In addition, in the aforementioned embodiment, there are two types of servers, the delivery company server 4 and the door control device server 3. However, the delivery company server 4 may be omitted and the reception unit 34 of the door control device server 3 may receive the unlock request (signal) directly from the business terminal 5.

Furthermore, the aforementioned embodiment is described by referring to the case where the delivery system 1 has the door control device 2 that controls the door 6. However, in the apartment building H, one or more shared devices such as the door 6 or an elevator (not shown) may be provided on the route from the entrance H1 to each room.

In that case, the delivery system 1 has the shared control device (including the function of the door control device 2) including the control unit that controls each shared device, instead of the door control device 2. The identification code is provided in the visible position in the apartment building H.

Furthermore, in place of the door control device server 3, the delivery system 1 includes the control device server (including the function of the door control device server 3) that is different in that it can communicate with the shared control device. The delivery company server 4 is capable of communicating with the control device server.

Furthermore, the business terminal 5 includes the control request unit (including the function of the unlock request unit 60) that transmits the first signal including the unlock request in the aforementioned embodiment to the delivery company server 4. The instruction unit 36 of the control device server transmits the control instruction (including the unlock instruction) for controlling the shared devices to the shared control device.

By doing as described above, for example, when the shared control device controls the elevator, the identification code provided near the elevator is read by the business terminal 5 of the delivery person d, so that the elevator can be stopped at the floor where the delivery person d is located by a control instruction from the shared control device, and moved toward the floor where the delivery destination room is located with the delivery person d on board.

That is, the delivery system 1 may include the shared control device including the control unit 21 that controls one or more shared devices located on the movement route from the entrance H1 of the apartment building H to each room; the control device server capable of communicating with the shared control device; the delivery company server 4 managed by the delivery company D of the package L and capable of communicating with the control device server; and the business terminal 5 owned by the delivery person d who delivers the package L and capable of communicating with the delivery company server 4. The business terminal 5 includes the identification code reading unit 57 that reads the identification code provided in a visible position in the apartment building H, and the control request unit that transmits the first signal to the delivery company server 4 when the identification code reading unit 57 reads the identification code. The delivery company server 4 includes the request reception unit 45 that receives the first signal from the business terminal 5, and the demand unit 46 that transmits the second signal to the control device server when the request reception unit 45 receives the first signal. The control device server includes the demand reception unit 34 that receives the second signal from the delivery company server 4, and the instruction unit 36 that transmits the instruction for controlling the shared devices to the shared control device when the demand reception unit 34 receives the second signal.

Furthermore, the shared control system 10 may have the shared control device including the control unit 21 that controls one or more shared devices located on the movement route from the entrance H1 of the apartment building H to each room; and the control device server that includes the reception unit 34 that receives the signal from the business terminal 5 or the delivery company server 4 linked to the business terminal 5 when the business terminal 5 reads the identification code provided in the visible position in the apartment building H, and the instruction unit 36 that transmits the instruction for controlling the shared devices to the shared control device when the reception unit 34 receives the signal.

1. A delivery system comprising:
a shared control device including a control unit that controls one or more shared devices on a movement route from an entrance of an apartment building to each room;
a control device server capable of communicating with the shared control device;
a delivery company server managed by a delivery company of a package and capable of communicating with the control device server; and
a business terminal owned by a delivery person who delivers the package and capable of communicating with the delivery company server,
the business terminal including
an identification code reading unit that reads an identification code provided in a visible position in the apartment building, and
a control request unit that transmits a first signal to the delivery company server when the identification code reading unit reads the identification code,
the delivery company server including
a request reception unit that receives the first signal from the business terminal, and
a demand unit that transmits a second signal to the control device server when the request reception unit receives the first signal, and
the control device server including
a demand reception unit that receives the second signal from the delivery company server, and
an instruction unit that transmits an instruction for controlling the shared devices to the shared control device when the demand reception unit receives the second signal.

2. A delivery system comprising:
a door control device including a control unit that controls locking and unlocking of a door installed at an entrance of an apartment building;
a door control device server capable of communicating with the door control device;
a delivery company server that is managed by a delivery company of a package and capable of communicating with the door control device server; and
a business terminal that is owned by a delivery person who delivers the package to the apartment building and capable of communicating with the delivery company server,
the business terminal including
an identification code reading unit that reads an identification code provided at a visible position at the entrance, and
an unlock request unit that transmits a first signal to the delivery company server when the identification code reading unit reads the identification code,
the delivery company server including
a request reception unit that receives the first signal from the business terminal, and
a demand unit that transmits a second signal to the door control device server when the request reception unit receives the first signal, and
the door control device server including
a demand reception unit that receives the second signal from the delivery company server, and
an instruction unit that transmits an unlock instruction for unlocking the door to the door control device when the demand reception unit receives the second signal.

3. The delivery system according to claim 2, wherein
the identification code includes device identification information that identifies the door control device,
the business terminal further includes an identification unit that acquires the device identification information from the identification code read by the identification code reading unit,
the first signal and the second signal include the device identification information acquired by the identification unit, and
the instruction unit transmits the unlock instruction to the door control device indicated by the device identification information included in the second signal.

4. The delivery system according to claim 3, wherein
the identification code further includes server identification information that identifies the door control device server,
the identification unit further acquires the server identification information from the identification code read by the identification code reading unit,
the first signal further includes the server identification information acquired by the identification unit, and
the demand unit transmits the second signal to the door control device server indicated by the server identification information included in the first signal.

5. The delivery system according to claim 2, wherein
the door control device further includes a display unit that displays the identification code on a screen,
the identification code includes random number information that is changed at a predetermined timing,
the business terminal further includes an identification unit that acquires the random number information from the identification code read by the identification code reading unit,
the first signal and the second signal include the random number information acquired by the identification unit,
the door control device server includes a random number determination unit that determines whether or not the random number information included in the unlock demand received by the5 demand reception unit is the newest, and
the instruction unit transmits the unlock instruction when the second signal is received by the demand reception unit and when the random number determination unit determines that the random number information is the newest.

6. A shared control system comprising:
a shared control device including a control unit that controls one or more shared devices located on a movement route from an entrance of an apartment building to each room; and
a control device server that includes a reception unit that receives a signal from a business terminal or a delivery company server linked to the business terminal when the business terminal reads an identification code provided in a visible position in the apartment building, and an instruction unit that transmits an instruction for controlling the shared devices to the shared control device when the reception unit receives the signal.

7. A shared control system comprising:
a door control device including a control unit that controls locking and unlocking of a door installed at an entrance of an apartment building; and
a door control device server including a reception unit that receives a signal from a business terminal or a delivery company server linked to the business terminal when the business terminal reads an identification code provided in a visible position at the entrance, and an instruction unit that transmits an unlock instruction for unlocking the door to the door control device when the reception unit receives the signal.
